(19) United States
(12) Patent Application Publication
(10) Pub. No.: US 2013/0069552 A1
(43) Pub. Date: Mar. 21, 2013

(54) ORGANIC ELECTROLUMINESCENT DEVICE WITH SPACE CHARGE/VOLTAGE INSTABILITY STABILIZATION DRIVE

(71) Applicants: Deeder Aurongzeb, Mayfield Heights, OH (US); Bruce Richard Roberts, Mentor-or-the-Lake, OH (US); Josip Brnada, Willoughby, OH (US)

(72) Inventors: Deeder Aurongzeb, Mayfield Heights, OH (US); Bruce Richard Roberts, Mentor-or-the-Lake, OH (US); Josip Brnada, Willoughby, OH (US)

(21) Appl. No.: 13/237,998

(22) Filed: Sep. 21, 2011

(51) Int. Cl. H05B 33/08

(52) U.S. Cl. 315/224

(57) ABSTRACT

An organic light emitting electrical device containing an organic light emitting diode (OLED) and a power supply adapted to reduce space charge buildup in the OLED. An organic electroluminescent device has an organic light emitting diode with a first electrode and a second electrode. A power supply is electrically coupled to the first electrode and the second electrode. The power supply is configured to generate a forward bias voltage and a reverse bias voltage pulse and alternately connect the forward bias voltage to the first electrode and the second electrode, and the reverse bias voltage pulse to the second electrode and the first electrode.

### BACKGROUND

1. Field of the Invention

The aspects of the present disclosure relate generally to the field of light emitting electrical packages, and in particular to supplying power, reduce operating voltage and electrical/optical instability to organic electroluminescent devices.

2. Description of Related Art

An Organic Light Emitting Diode (OLED) is a type of electroluminescent device in which light is generated within an organic compound formulated to emit light when electric current is applied. OLEDs are well known in the art and are typically built as a laminate on top of a suitable substrate material such as glass or a polymer. An OLED consists of one or more layers of organic material sandwiched between two electrodes. One electrode is a negatively charged cathode usually made from a highly reflective metal and the other is a positively charged anode usually made from a transparent conductive metal oxide. Photons generated in the organic material will be reflected off the metallic cathode or pass through the transparent anode to exit the device as light. When a voltage is applied across the two electrodes, a current of electrons flows from the cathode, through the organic material to the anode. Electrons enter the lowest unoccupied molecular orbit (LUMO) of the organic material from the cathode and exit from the highest occupied molecular orbit (HOMO) of the organic material to the anode. Electrons exiting the organic material leave behind positively charged regions called holes. When these electrons and holes meet at a luminescent center, usually in an organic molecule or polymer, they combine to form excitons which will decay releasing photons. The released photons have a frequency proportional to the energy gap between the HOMO and LUMO of each emitting molecule. The generated photons can then pass through the transparent substrate and exit from the bottom of the device as light.

An OLED is commonly fabricated from two types of organic materials, small molecules and polymers. Commonly used small molecules include organometallic chelates, fluorescent and phosphorescent dyes and conjugated dendrimers. A second type of OLED is constructed from conductive electroluminescent or electro-phosphorescent polymers. These devices are sometimes referred to as Polymer Light Emitting Diodes (PLED) or Polymer Organic Light Emitting Diodes (P-OLED). Typical polymers used in P-OLED construction include electroluminescent derivatives of poly(p-phenylene vinylene) and polyfluorene or electro-phosphorescent materials such as poly(vinylcarbazole). Traditionally, the term OLED referred only to devices constructed from small molecules. However in recent years OLED has been used to refer to both small molecule and polymer type of devices. For the purposes of this disclosure the terra Organic Light Emitting Diode and the acronym “OLED′” is defined to refer generally to electroluminescent devices constructed using both types of organic material. When referring to a specific type of organic material, SM-OLED is used to describe a Small Molecule Organic Light Emitting Diode, and P-OLED is used to refer to a Polymer Organic Light Emitting Diode.

The organic material serves three main functions: hole transport, electron transport, and emission. A basic three layer device uses a layer of n-type material for the electron transport layer (ETL), a layer of p-type material for the hole transport layer (HTL), with emissive layer (EML) of electroluminescent material, usually fluorescent or phosphorescent dyes, in between. The emissive layer can be either a separate layer in between the ETL and HTL or a dopant, close to the recombination zone, in one of these layers. Layers may be combined or additional layers may or may not be included in the light emitting structure without straying from the fundamental concept of an organic light emitting diode (OLED) presented here.

OLEDs have the potential for being very efficient light sources. In order to optimize OLED efficiency, the distribution of charges must be balanced within the device. The calculation of carrier distribution in the organic layers can be quite complex due to the presence of both types of charge carriers, electrons as well as holes, in working devices. Consequently recombination and neutralization of carriers must be regarded. OLED device operation is determined by three processes: charge injection, charge transport and recombination. The dominant effect in hole and electron currents has been long discussed. The basic equations describing electron transport and distribution are well known (see J. Appl. Phys. 100, 084502-2006) and are the current-flow equation for carrier drift and the Poisson equation,

$${J}_{0} = e μ nE , \\ \frac{ɛ}{e} \frac{d E}{d x} = - n ,$$

where μis the drift mobility, which is assumed constant, n is the electron carrier density, e is the elementary charge, J₀ is the steady-state current density, which is constant across the sample, ε is the dielectric constant, and E is the electric field intensity. The solution of the above equations with boundary condition E=0 at the cathode is given by the Mott-Gurney square-law equation,

$${J}_{0} = \frac{9}{8} ɛμ \frac{{V}_{0}^{2}}{{L}^{3}} ,$$

where V₀ is the voltage across the organic layer. Note that current flow and efficiency of the device depends on defect formation and electric field. Space charge formation due to electric field can be great. Space charge can build up at the electrodes and at abrupt interlayer boundaries between the organic materials used in the ETL, EML, and HTL.

Space charge causes a number of problems in OLEDs. Space charge can cause chromatic variations across the surface of an OLED, and instability of the space charge regions can lead to undesirable flickering effects. In large area OLEDs, such as those used in lighting applications, these effects become even more noticeable and therefore more undesirable. When space charge is sustained over extended periods of time, it can damage the organic materials thereby limiting the useful lifetime of the device. Because space charge tends to oppose voltage applied to the device it increases the required operating voltage resulting in lower efficiency.

For many purposes, one may desire light emitting devices or OLEDs to be generally flexible, i.e. are capable of being bent into a shape having a radius of curvature of less than about 10 cm. These light emitting devices are also preferably large-area, which means they have a dimension of an area greater than or equal to about 10 cm², and in some instances are coupled together to form a generally flexible, generally planar OLED panel comprised of one or more OLED devices, which has a large surface area of light emission. Flexible OLED devices usually comprise a flexible polymeric substrate, which while flexible, does not prevent moisture and oxygen penetration.

Accordingly, it would be desirable to provide an organic light emitting diode device that addresses at least some of the problems identified above.

### SUMMARY OF THE INVENTION

As described herein, the exemplary embodiments overcome one or more of the above or other disadvantages known in the art.

One aspect of the exemplary embodiments relates to an organic electroluminescent device. In one embodiment the device includes an organic light emitting diode having a first electrode and a second electrode. A power supply is electrically coupled to the first electrode and the second electrode and is configured to generate a forward bias voltage and a reverse bias voltage pulse. The power supply is configured to alternately connect a forward bias voltage to the first electrode and the second electrode, and a reverse bias voltage pulse to the second electrode and the first electrode.

Another aspect of the exemplary embodiments relates to a method for reducing space charge in an organic light emitting diode that includes a first and second electrode. In one embodiment, the method includes applying a forward bias voltage across the first and second electrode of the organic light emitting diode such that light is generated in an electroluminescent layer of the organic light emitting diode; applying a reverse bias pulse across the first and second electrode of the organic light emitting diode such that space charge is removed; and re-applying the forward bias voltage across a first and second electrode of the organic light emitting diode.

Another aspect of the exemplary embodiments relates to an organic electroluminescent device. In one embodiment, the device includes an organic light emitting diode having a first electrode and a second electrode; an H-Bridge drive circuit having a center leg, a first upper leg, a second upper leg, and two lower legs; a signal generator; and a power supply having a first voltage and a second voltage, wherein each of the first upper leg, second upper leg and two lower legs of the H-Bridge comprises a switch; wherein the first and second electrode are electrically connected across the center leg of the H-Bridge, the first upper leg is configured to receive the first voltage from the power supply, the second upper leg is configured to receive the second voltage from the power supply, the two lower legs are electrically connected to an electrical ground, and the signal generator is configured to alternately energize the switches as a first pair and a second pair; and wherein when the first pair of switches is energized the first electrode is electrically connected to the first voltage and the second electrode is electrically connected to the electrical ground, and when the second pair of switches is energized the second electrode is electrically connected to the second voltage and the first electrode is electrically connected to the electrical ground.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

In the drawings:

FIG. 1 illustrates an exemplary OLED device;

FIG. 2 illustrates a voltage-to-generated light relationship for an exemplary OLED incorporating aspects of the present disclosure;

FIG. 3 illustrates an exemplary embodiment of a power drive signal for an exemplary OLED incorporating aspects of the present disclosure;

FIG. 4 illustrates an exemplary embodiment of an H-Bridge drive circuit for energizing an exemplary OLED incorporating aspects of the present disclosure; and

FIG. 5 illustrates an exemplary embodiment of a drive circuit used during testing of an exemplary OLED incorporating aspects of the present disclosure.

### DETAILED DESCRIPTION OF THE DISCLOSED EMBODIMENTS

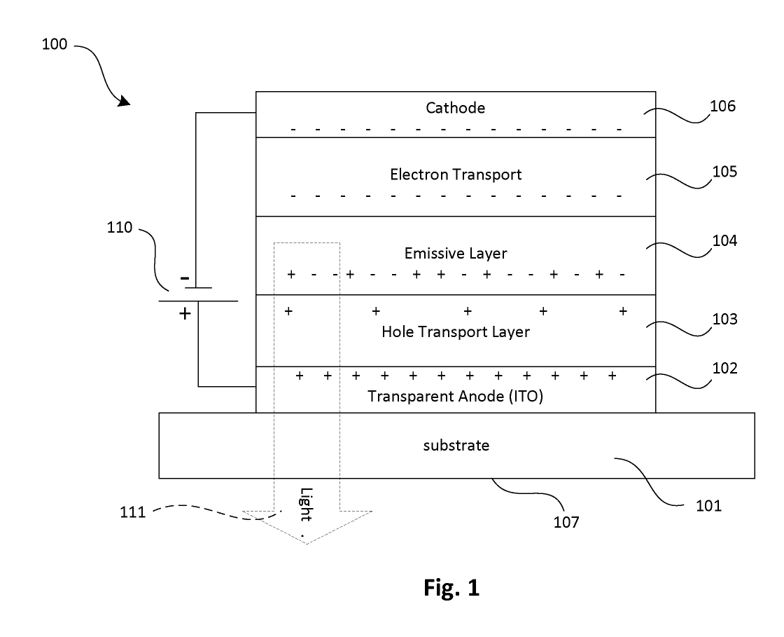

Referring to FIG. 1, an exemplary OLED device in accordance with aspects of the disclosed embodiments is shown. The aspects of the disclosed embodiments are directed to removing space charge from an OLED device, such as that shown in FIG. 1, without noticeably interrupting the light output of the OLED device. FIG. 1 illustrates OLED device 100, in which organic layers 103, 104, and 105 are sandwiched between two electrodes 102,106 disposed atop a substrate 101. In the embodiment shown in FIG. 1, the substrate 101 is comprised of transparent materials, such as glass or polymer. As shown in the example of FIG. 1, the top electrode 106 is configured as a negatively charged cathode and the bottom electrode 102 is configured as a positively charged anode. The cathode 106 is made from a highly reflective metallic material that will reflect photons travelling upward back toward the substrate 101 while the anode 102 is made from a transparent conductive metal oxide that will allow photons to pass through. The OLED device 100 shown in FIG. 1 is configured as a bottom-emitting OLED device where light 111 generated in the emissive layer 104 is reflected off the top electrode 106 or passes through the bottom electrode 102 and exits through the bottom surface 107 of the transparent substrate 101.

In the exemplary embodiment illustrated in FIG. 1, the OLED device 100 has three distinct organic layers: a hole transport layer (HTL) 103, an emissive layer (EML) 104, and an electron transport layer (ETL) 105. As noted above, layers 103, 104 and 105 may be combined or additional layers may or may not be included without straying from the concept of an organic light emitting diode (OLED) as used in the present disclosure. The HTL 103 is comprised of an organic semiconductor that has been doped with atoms capable of producing an excess of positive charge carriers, also known as p-type charge carriers or holes. The emissive layer 104 is typically comprised of fluorescent dyes or phosphorescent dyes. The ETL 105 is comprised of an organic semiconductor that has been doped with atoms capable of providing extra conduction electrons which produce an excess of negative, or n-type, charge carriers. The emissive layer 104 can be either a layer in between the ETL 105 and HTL 103 as shown in FIG. 1, or alternatively it can comprise a dopant, typically fluorescent or phosphorescent dyes, in the ETL 105 or HTL 103 close to the recombination zone. When a voltage 110 is applied across the two electrodes 102, 106, a current of electrons flows from the top electrode 106 through the organic layers 103, 104, and 105 to the bottom electrode 102. Electrons enter the lowest unoccupied molecular orbit (LUMO) of the ETL layer 105 and exit from the highest occupied molecular orbit (HOMO) of the HTL 103. The HOMO and LUMO of organic semiconductors are analogous to the valence and conduction bands in inorganic semiconductors. Electrons exiting the hole transport layer 103 leave behind positively charged regions called holes. Electrostatic forces draw these holes into the emissive layer 104 where they combine with electrons at a luminescent center, usually in an organic molecule or polymer, resulting in the release of photons. The released photons have a frequency proportional to the energy gap between the HOMO and LUMO of each emitting molecule. Generated photons pass through the transparent substrate 101 and exit from the bottom surface 107 of the OLED device 100 as light.

In the OLED device 100 shown in FIG. 1, light 111 generated in the organic material exits the device 100 by passing through the transparent substrate 101 and out the bottom surface 107. The transparent substrate 101 is typically referred to as the bottom of the device 100 and configurations where light exits through the bottom surface 107 of the transparent substrate 101 are generally referred to as bottom-emitting devices. The aspects of the disclosed embodiments can also include an inverted or top-emitting device configuration. In a top-emitting configuration the reflective cathode 106 is placed near the transparent substrate 101 and the transparent anode 102 is placed above the emissive layer 104 resulting in a configuration where generated light is reflected off the bottom electrode 102 and exits through the top of the device. In a top-emitting configuration the cathode 106 is on the bottom next to the transparent substrate 101 where it can be used as the drain of an n-channel thin film transistor (TFT), allowing for construction of a low cost TFT backplane underneath the light emitting regions. A TFT backplane is useful for making active-matrix OLED displays. By using transparent materials in all layers of the OLED device, i.e. both electrodes 102 and 106 as well as substrate 101 are transparent, a fully transparent OLED can be created. Fully transparent OLED devices can be used to create devices such as heads-up displays, for example. The terms organic light emitting diode and OLED as used in this disclosure refer generally to any of these configurations.

For context, hereinbelow are described additional features of an organic light emitting electrical package of the present disclosure. The organic light emitting electrical package as a whole is configured to be flexible and/or conformal; that is, the light emitting electrical package comprises flexibility sufficient to “conform” to at least one predetermined shape, at least once. For example, as will generally be understood, a “conformal” light emitting electrical package may be initially flexible enough to wrap around a cylinder body to form a fixture, and then not be flexed again during its useful lifetime. Alternatively, the light emitting electrical package may remain generally flexible over its useful lifetime such as for a flexible display that may be rolled up for storage. The light emitting electrical packages according to the present disclosure are generally flexible (or conformable).

Generally, the anode layer 102 may be comprised of a substantially transparent nonmetallic conductive material. The requirements for a good transparent conductive nonmetallic coating (e.g., ITO) for OLED applications can be summarized by high light transmission (>than about 90%), low sheet resistance of 1 to 50 Ω/sq, high work function (sometimes as high as 5.0 eV) and low roughness below 1 nm (RMS). However, as a practical matter such desired parameters are not always easily achieved. Furthermore, transparent conductive nonmetallic coatings are typically brittle and may have defects due to processing conditions. Suitable materials for embodiments of the present disclosure include, but are not limited to, transparent conductive oxides such as indium tin oxide, indium gallium oxide (IGO), aluminum doped zinc oxide (AZO), fluorine doped tin oxide (FTO), zinc oxide, zinc-oxide-fluoride (fluorine doped zinc oxide), indium doped zinc oxide, magnesium indium oxide, and nickel tungsten oxide; conductive polymers such as poly(3,4-ethylenediosythiophene)poly(styrenesulfonate) (PEDOT:PSS); and mixtures and combinations or alloys of any two or more thereof. Other substantially transparent nonmetallic conductive materials would be apparent to those of ordinary skill in the field.

Cathodes, such as cathode 106 shown in FIG. 1, generally may comprise a material having a low work function such that a relatively small voltage causes the emission of electrons. Commonly used materials include metals such as tin, lead, aluminum, silver, and mixtures are used with metal or metal iodides of zirconium, calcium, barium, magnesium, rare earth elements or alloys of any two or more thereof. Alternatively, the cathode 106 may comprise two or more layers to enhance electron injection. Non-limiting examples of the cathode 106 may comprise a thin layer of calcium followed by a thicker outer layer of aluminum or silver.

In certain embodiments, the organic light-emitting layer 104 is built up over the first electrode layer 102 by solution-phase deposition, followed by solvent-assisted wiping or other patterning, and then a cathode layer 106 is deposited over the organic light emitting layer by a vapor deposition, e.g., 100-1000 nm thick aluminum film. In one embodiment, the OLED device 100 comprises a continuous un-patterned anode layer 102 and a discontinuous cathode layer 106 configured in a plurality of ribbon-like structures. The term “ribbon-like” refers to the dimensions of the lighted areas of the device 100, which may be long and narrow and thin in cross-section.

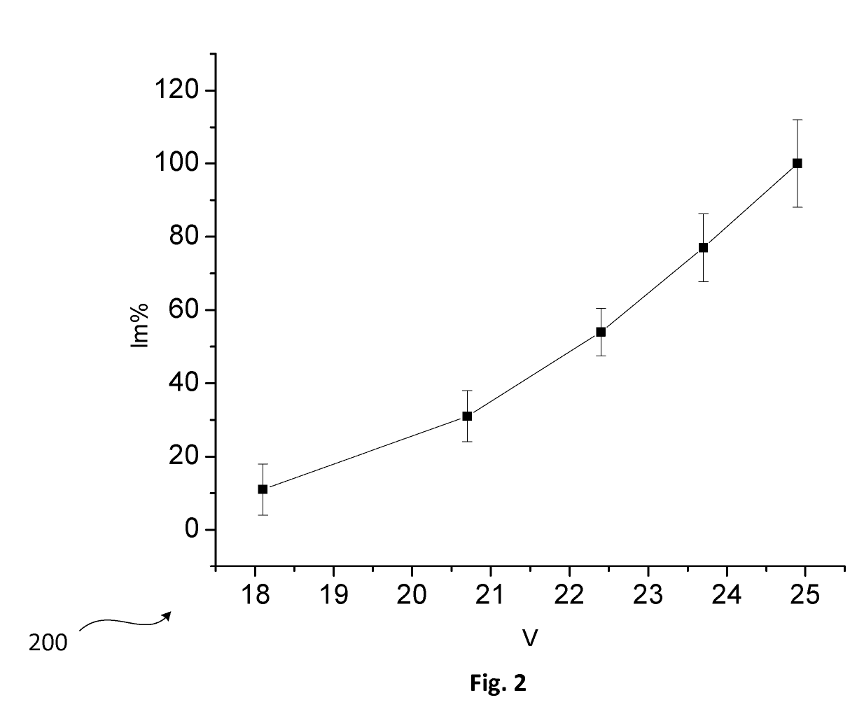

Organic light emitting diodes tend to be very efficient making them attractive for lighting applications. Large area devices being designed for these lighting applications often require a driving voltage excess of 10 volts and it is not uncommon for these devices to operate with driving voltages between 18 to 25 volts. To turn the OLED on, a forward biased voltage is applied to the device 100 with the positive voltage being applied to the anode 102 and the negative voltage applied to the cathode 106 causing current to flow from the anode 102 to the cathode 106 (i.e. electrons flow from the cathode to the anode). FIG. 2 shows the relationship between the applied voltage and percentage of maximum luminescence measured from a set of typical devices designed for use in lighting applications. As can be seen from this curve 200, the lamps drop out, i.e. stop emitting light, at about 18 volts and reach about 100% luminescence at around 25 volts. For dimming applications the voltage can be varied over a luminescent voltage range of about 18 to 25 volts to provide a light output of about 10% to about 100%. The luminescent voltage range is the range of forward bias voltage values that cause light to be generated when applied across the electrodes 102, 106, of the organic light emitting diode device 100.

When holes are injected into the HTL 103 from the anode 102 excess electrons are left behind in the anode 102. Likewise, when electrons are injected into the ETL 105 excess positive charge is left in the cathode 106. In perfect conductors these excess charges would be continuously drained off, however materials used for electrodes 102, 106, as well as the organic semiconductors are not perfect conductors and limit mobility of the charge carries. This results in the build-up of an electric charge, known as a space charge, in regions of the device 100. Space charge builds up around the electrodes 102, 106, and can also buildup at abrupt interlayer boundaries between the organic materials used for the ETL 105, EML 104, and HTL 103. This space charge tends to oppose the forward bias voltage thereby reducing the amount of current flowing in the device 100. In effect the space charge is limiting the amount of current flowing through the device 100. Space charge build up causes a number of undesirable effects in OLED lighting devices. It can cause instabilities resulting in flickering or it can manifest as uneven light output across the surface of the device. Space charge can cause chromatic variations that result in undesirable color variations. When the organic compounds are exposed to space charge for extended periods of time, as would be the case in lighting applications, the organic compounds can be damaged reducing the usable lifetime of these electroluminescent devices.

Aspects of the present disclosure address methods of removing space charge from an OLED. Applying a reverse bias voltage, which means applying a negative voltage to the anode 102 and a positive voltage to the cathode 106, can quickly remove built up space charge from an OLED device 100. Applying the reverse bias voltage, V_{rb}, for an extended period of time will stop generation of light and turn the device 100 off which can cause undesirable effects. If however, the reverse bias voltage is applied as a pulse 301 of relatively short duration, the light output of the device 100 is not noticeably interrupted.

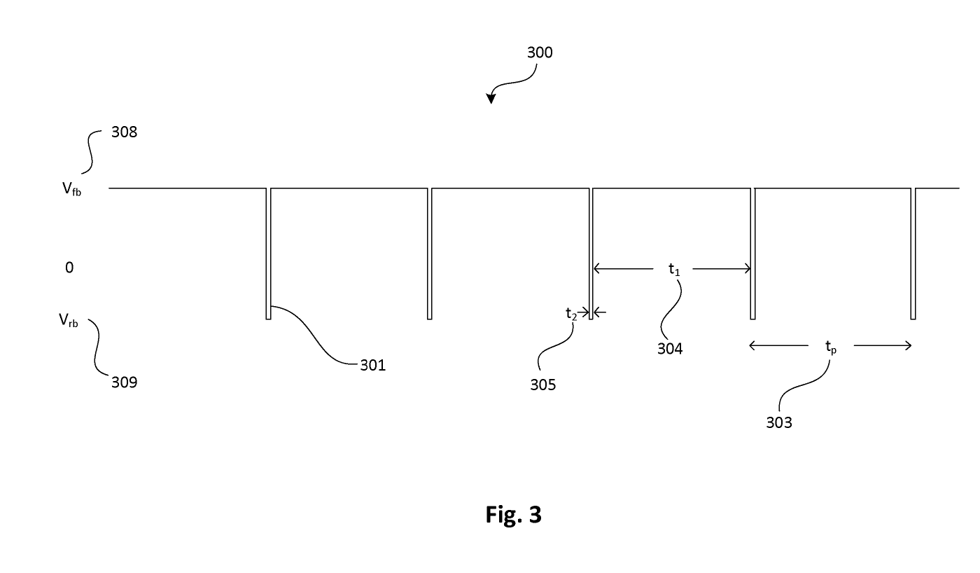

FIG. 3 shows an example of a drive signal 300 that can be applied to the OLED device 100 of FIG. 1 to remove space charge from the OLED device 100 without noticeably interrupting the light. When the OLED device 100 is turned on the forward bias voltage 308, V_{fb}, is applied to the OLED device 100 to sustain generation of light. In an exemplary embodiment short pulses 301 of the reverse bias voltage 309, V_{rb}, are periodically applied to the OLED device 100 in order reduce and stabilize space charge buildup. A pulses with duration of about one microsecond or less can effectively remove any space charge that has built up.

Perception speed of the eye is a complex question but it is generally accepted that events with duration of less than a few milliseconds will not be negatively perceived. For example, the power grid in North America operates at 60 Hz and in Europe at 50 Hz, resulting in flicker of fluorescent lighting with a period of about 5 to about 8 milliseconds. This is generally viewed as acceptable. The electrical time constant of OLEDs is on the order of about 10 μs (microseconds). A parameter can be defined that represents the time elapsed before the intensity of delayed electroluminescence (EL) decreases to half of its value at the time the forward bias voltage is turned off, referred to as delayed EL half-life and denoted by t_{1/2}. For a typical OLED device 100 t_{1/2} is about 900 μs. Thus, a reverse bias pulse of one to a few microseconds applied to OLED device 100 will cause little variation in light output of the device 100. Charge neutralization can be accomplished in less than 1 microsecond (μs). One exemplary embodiment of the drive signal illustrated in FIG. 3 has reverse bias pulses 301 with duration t₂ 305 on the order of a microsecond and a voltage 309 (V_{rb}) of −9.2 volts, and a forward bias voltage 308 (V_{fb}) of 18.4 volts applied to OLED device 100 during the remainder of the period t₁ 304. In the exemplary embodiment shown the frequency of the reverse bias pulses 301 (which is the inverse of the period time tₚ 303) can run from about 100 hertz to about 2 kilohertz. Those skilled in the art will recognize that the magnitude of the forward bias voltage and reverse bias pulse are highly dependent on the particular type of OLED chosen and that a wide range of voltage values can be used without straying from the spirit and scope of the disclosure. Also, a wide range of reverse bias pulse durations and frequencies is also possible and are within the spirit and scope of the disclosure.

FIG. 3 illustrates a supply signal where the reverse bias pulses 301 are applied at regular intervals. This interval should be less than a few milliseconds, for example less than 8 milliseconds and preferably less than one millisecond, to avoid noticeable light fluctuations. The reverse bias pulses do not need to be periodic in nature to remove the space charge. Those skilled in the art will recognize that the reverse bias pulses can be applied in any fashion and will still effectively reduce or remove the space charge. In an exemplary embodiment an optical sensor could be employed to detect flicker, brightness variations, or chromatic variations and apply one or more reverse bias pulses until the space charge is removed or stabilized and the OLED 100 is returned to a desired condition. It should be noted that OLED itself can act as a sensor. During optical variation some voltage fluctuation is always observed, this signal can be used to identify instability within the device. Intermittent reverse bias pulse schemes, such as those applied by the optical sensor scheme described above, allow space charge to be removed with reduces losses from switching.

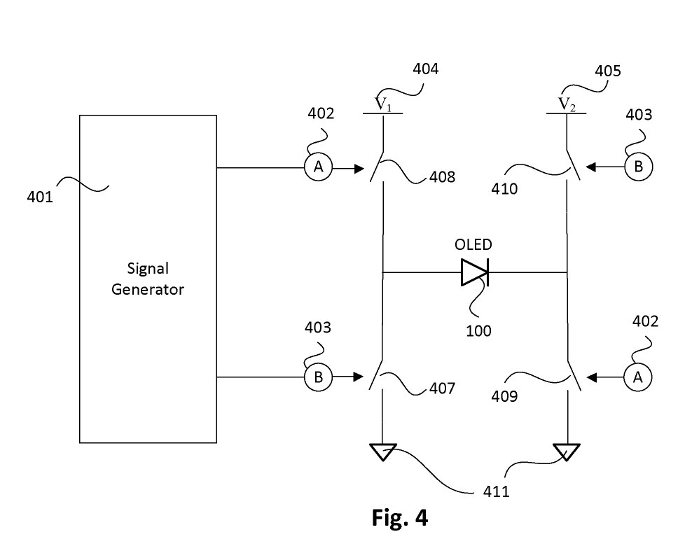

An exemplary embodiment of an OLED driving device that can be used to apply drive signal 300 to an OLED 100 is shown in FIG. 4. This circuit employs an H-Bridge where the OLED 100 is in the center leg of the H-Bridge and the two lower legs, comprising switches 407 and 409, are connected to electrical ground 411. A power supply (not shown) provides supply voltages 404 and 405 that provide the forward bias power 404 (V₁) and reverse bias power 405 (V₂). The signal generator 401 is used to operate a set of four electronic switches 407, 408, 409, and 410 where one switch is in each leg of the H-Bridge. The four switches 407, 408, 409, and 410 can be any solid state device, for example field effect transistor, bipolar junction transistor, etc., or other electrical or electromechanical device capable of efficiently switching the necessary voltages and currents (current levels can be from milliamps to tens of amps depending on the type of OLED 100) used to power the OLED 100. When a control signal 402 and 403 is applied to one of the switches 407, 408, 409, 410 the particular switch is energized and allows current to flow through the corresponding leg of the H-Bridge. When a switch 407, 408, 409, 410 is not energized, substantially no current will flow through it. The switches 407, 408, 409, 410 are energized as pairs where switches 408 and 409 comprise a first pair A and switches 407 and 410 comprise a second pair B. The signal generator 401 is configured to energize only one pair of switches at a time so when pair A is energized, pair B is not energized and vise-versa. Thus the signal generator 401 alternately applies each of the supply voltages to the OLED 100. The signal generator 401 will also take care of any delays or overlap necessary to prevent shorting the supply voltages 404 and 405 to ground and to minimize any gaps in supply voltage applied to the device 100. Those skilled in the art will recognize that additional components, such as current limiting resistors, may or may not be added to the legs of the H-Bridge without straying from the scope and spirit of the disclosure. When neither switch pair A or B is energized, no voltage is applied to OLED 100 and the device is turned off. When switch pair A is energized, the forward bias power 404 (V₁) drives current through the OLED 100 turning it on and generating light. Energizing switch pair B connects reverse bias power 405 (V₂) to OLED 100 with opposite polarity from the forward bias power 404 connected by switch pair A thereby reverse biasing OLED device 100. By using signal generator 401 to energize switch pair B for only a brief time and then re-energizing switch pair A, a short reverse bias pulse is applied across OLED 100. As an example, referring to the drive signal 300 shown in FIG. 3, energizing switch pair A connects the forward bias power 404 to OLED device 100 resulting in a forward bias voltage V_{fb} 308 of about 18.2 volts across the OLED device 100 thereby turning the OLED device 100 on. The reverse bias pulses 301 is created by energizing switch pair B for about 1 microsecond which connects the reverse bias power 405 to OLED device 100 resulting in a reverse bias voltage V_{rb} of about −9.2 volts applied across OLED device 100, then re-energizing switch pair A thereby returning OLED 100 to the forward bias condition. The short reverse bias pulse 301 removes space charge from the OLED device 100 without noticeably affecting its light output.

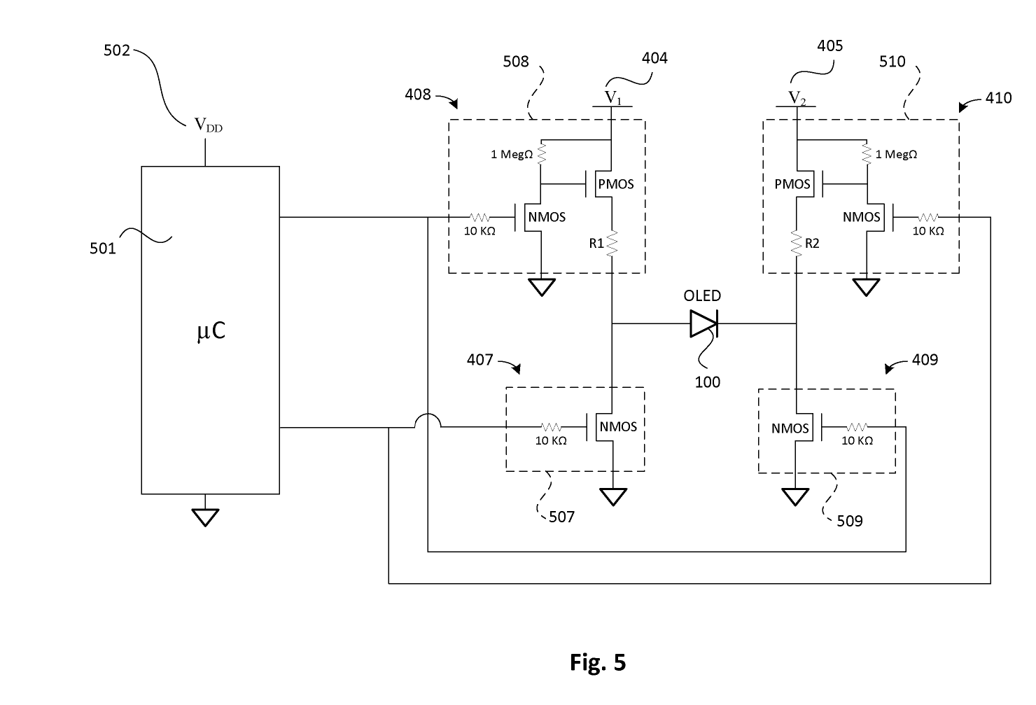

Referring now to FIG. 5, an exemplary embodiment of an H-Bridge drive device, as described above, is shown. The embodiment illustrated in FIG. 5 was used during testing of the embodiments of the present disclosure. In the exemplary embodiment shown the switches 407, 408, 409, 410 of the H-Bridge described with respect to FIG. 4 are implemented with circuits 507-510 respectively. The signal generator 401 of FIG. 4 is implemented in the circuit of FIG. 5 using a micro-controller 501 powered by a supply voltage 502. Also shown in this embodiment are current limiting resistors R1 and R2. These resistors limit the current flowing through the OLED 100 to a maximum allowable value to prevent damaging the OLED device 100. One skilled in the art will recognize that the maximum amount of current allowed, and thus the values of R1 and R2, are dependent on the specifics of the OLED 100 being used and should be chosen accordingly.

Embodiments of the invention may comprise a method for reducing space charge in an organic light emitting diode, which includes a first electrode and a second electrode. Unless otherwise indicated, the method steps are performed by an apparatus, such as a circuit, a processor, a power supply, etc., and may be performed in any suitable order.

For example, one such exemplary method may comprise applying a forward bias voltage across the first electrode and the second electrode of the organic light emitting diode such that light is generated in an electroluminescent layer of the organic light emitting diode. The method may further comprise applying, using an embodiment of the power supply described herein, a reverse bias pulse across the first electrode and the second electrode of the organic light emitting diode such that space charge is removed. The method may also further comprise re-applying, via the power supply, the forward bias voltage across the first electrode and the second electrode of the organic light emitting diode.

The method may further comprise varying the forward bias voltage, via the power supply, over a luminescent voltage range of the organic light emitting diode thereby dimming a light generated by the organic light emitting diode. In one embodiment, the steps of applying a forward bias voltage, applying a reverse bias pulse, and re-applying the forward bias voltage can be performed such that a series of two or more reverse bias pulses are applied to the organic light emitting diode, wherein the reverse bias pulses are separated by regular intervals. Alternatively, the steps of applying a forward bias voltage, applying a reverse bias pulse, and re-applying the forward bias voltage can be performed such that a series of two or more reverse bias pulses are intermittently applied to the organic light emitting diode.

Thus, while there have been shown, described and pointed out, fundamental novel features of the invention as applied to the exemplary embodiments thereof, it will be understood that various omissions and substitutions and changes in the form and details of devices and method(s) illustrated, and in their operation, may be made by those skilled in the art without departing from the spirit and scope of the invention. Moreover, it is expressly intended that all combinations of those elements and/or method steps, which perform substantially the same function in substantially the same way to achieve the same results, are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An organic electroluminescent device, comprising:
an organic light emitting diode having a first electrode and a second electrode; and
a power supply electrically coupled to the first electrode and the second electrode, the power supply configured to generate a forward bias voltage and a reverse bias voltage pulse;
wherein the power supply is configured to alternately connect a forward bias voltage to the first electrode and the second electrode, and a reverse bias voltage pulse to the second electrode and the first electrode.

2. The organic electroluminescent device of claim 1, wherein the power supply is configured to vary the forward bias voltage over a luminescent voltage range of the organic light emitting diode.

3. The organic electroluminescent device of claim 1, wherein the power supply alternates between the first bias voltage and the reverse bias pulse such that a series of one or more reverse bias pulses are applied to the organic electroluminescent device at regular intervals.

5. The organic electroluminescent device of claim 1, wherein the reverse bias pulse has duration of less than 5 microseconds.

6. The organic electroluminescent device of claim 1, wherein the configuration of the power supply comprises an H-Bridge circuit.

7. The organic electroluminescent device of claim 3, wherein the one or more reverse bias pulses is applied to the organic electroluminescent device intermittently.

8. A method for reducing space charge in an organic light emitting diode comprising a first electrode and a second electrode, the method comprising:
applying a forward bias voltage across the first electrode and the second electrode of the organic light emitting diode such that light is generated in an electroluminescent layer of the organic light emitting diode;
applying a reverse bias pulse across the first electrode and the second electrode of the organic light emitting diode such that space charge is removed; and
re-applying the forward bias voltage across the first electrode and the second electrode of the organic light emitting diode.

9. The method of claim 8, further comprising:
varying the forward bias voltage over a luminescent voltage range of the organic light emitting diode thereby dimming a light generated by the organic light emitting diode.

10. The method of claim 8, wherein the applying a forward bias voltage, applying a reverse bias pulse, and re-applying the forward bias voltage are performed such that a series of two or more reverse bias pulses are applied to the organic light emitting diode wherein the reverse bias pulses are separated by regular intervals.

11. The method of claim 8, wherein the applying a forward bias voltage, applying a reverse bias pulse, and re-applying the forward bias voltage are performed such that a series of two or more reverse bias pulses are intermittently applied to the organic light emitting diode.

12. An organic electroluminescent device, comprising:
an organic light emitting diode having a first electrode and a second electrode;
an H-Bridge drive circuit having a center leg, a first upper leg, a second upper leg, and two lower legs;
a signal generator; and
a power supply having a first voltage and a second voltage,
wherein each of the first upper leg, second upper leg and two lower legs of the H-Bridge comprises a switch;
wherein the first and second electrode are electrically connected across the center leg of the H-Bridge, the first upper leg is configured to receive the first voltage from the power supply, the second upper leg is configured to receive the second voltage from the power supply, the two lower legs are electrically connected to an electrical ground, and the signal generator is configured to alternately energize the switches as a first pair and a second pair; and
wherein when the first pair of switches is energized the first electrode is electrically connected to the first voltage and the second electrode is electrically connected to the electrical ground, and when the second pair of switches is energized the second electrode is electrically connected to the second voltage and the first electrode is electrically connected to the electrical ground.

13. The organic electroluminescent device of claim 12, wherein the power supply is configured to vary the first voltage over a luminescent voltage range of the organic light emitting diode.

14. The organic electroluminescent device of claim 12, wherein the power supply alternately energizes the first pair of switches and the second pair of switches pulse such that a series of one or more reverse bias pulses are applied to the organic electroluminescent device at regular intervals.

15. The organic electroluminescent device of claim 14, wherein the one or more reverse bias pulses is applied to the organic electroluminescent device intermittently.
